(19) United States
(12) Patent Application Publication
(10) Pub. No.: US 2009/0161811 A1
(43) Pub. Date: Jun. 25, 2009

(54) REFUELING SUPPORT SYSTEM

(75) Inventors: Hitoshi SATO, Yokohama-Shi (JP); Junichi KOYAMA, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: GLOBAL NUCLEAR FUEL-JAPAN CO., LTD., Yokosuka-Shi (JP)

(21) Appl. No.: 12/342,298

(22) Filed: Dec. 23, 2008

(30) Foreign Application Priority Data
Dec. 25, 2007 (JP) 2007-332660

(51) Int. Cl. G21C 19/00

(52) U.S. Cl. 376/268

(57) ABSTRACT

Problem: To provide a refueling support system in which fuel transfer procedure establishing operations and associated operations precisely reflecting the fuel burnup conditions can be efficiently performed at the time of scheduled outages at a nuclear power plant.

Solution: a reactor core performance calculation means for evaluating neutronic characteristics per fuel assembly from core loading pattern input data of a reactor core before beginning of refueling at the end of a predetermined cycle n and candidate reactor cores at the end of refueling at the beginning of the following cycle n+1 and from core performance calculation results from a process computer;

a transfer condition setting means for determining an intermediate fuel loading pattern target which should be realized in the process of refueling from transfer condition input data including Intermediate fuels-to-be-unloaded and transfer priority levels, and

a transfer procedure planning means for determining fuel transfer procedures from the neutronic characteristics per fuel assembly which are output from said reactor core performance calculation means and from the Intermediate fuel loading pattern target which is output from said transfer condition setting means are comprised.

### CROSS-REFERENCE TO RELATED APPLICATIONS

This application is based upon and claims the benefit of priority from prior Japanese Patent Application No. 2007-332660, filed Dec. 25, 2007, the entire contents of which are incorporated herein by reference.

### BACKGROUND OF THE INVENTION

1. Field of the Invention

This invention involves refueling technologies which are applied to fuel loading, unloading, exchange, etc. in a nuclear reactor at a nuclear power plant, and more specifically, relates to a refueling support system comprising a reactor core performance calculation means which evaluates neutronic characteristics per fuel assembly and a transfer condition setting means which determines an intermediate fuel loading pattern target that should be realized in the process of refueling, both of which working together to enable safe fuel transfer procedures to be determined promptly at the time of scheduled outages.

2. Description of Relate

In nuclear power plants a scheduled outages is conducted after approximately 1-year operation to perform fuel replacement, rearrangement, etc. as well as to inspect and maintain the main equipment. Normally, fuel transfer operations to perform fuel replacement and rearrangement require a total of 2-3 weeks.

In order to improve the utilization rate of a nuclear plant, it is desired to make the period of the scheduled outage shorter. Consequently the site engineers are needed to formulate a proper and efficient plan for the fuel transfer operations which can be a critical path through the scheduled outage process.

In addition, the destination of fuel transfer is based on the result of a reactor core design in which safety and economics are considered, and in order to achieve more proper results, the reactor core design is conducted based on the results of track record evaluation of burnup conditions of nuclear fuel by reactor core performance calculation of a process computer.

Normally, an offsite design firm conducts the reactor core design, and a power plant site develops a plan for the procedures relating to refueling operations (fuel transfer planning). This is because the database of neutronic characteristics of fuels and the analysis programs for designing to conduct reactor core designs are managed by design engineers, while the conditions of scheduled outages of the equipment relating to the refueling operations and the positioning management information of fuel assemblies such as new or spent fuels etc. are managed by site engineers at a power plant. Both parties have their own quality programs independent from each other, and, in the field of information management and engineering skills, it is difficult to realize a centralized management across all of these design management activities.

Conventionally, the information of the neutronic characteristics of a reactor core is provided for each operation cycle of related core design and based on the quality programs of both the design firm and the power plant. However, in order to establish proper neutronic characteristics information, it is necessary that the design firm receives feedback about the information of burnup conditions of the core fuel based on reactor core performance calculation of a process computer.

The reactor core design requires processes for evaluations and quality reviews in consideration of design conditions and other conditions in terms of safety and economics, which generally takes more than 1 month. For this reason, feedback about the burnup conditions from a process computer is provided to the design firm on a timely basis during the operation cycle as well, and, before the cycle operation is completed, the fuel loading patterns and the running operations, such as control rod operations, for the next operation cycle are determined.

Fuel loading patterns cannot be changed during a power operation of the reactor, but a certain degree of reactor core characteristics deviation from ones predicted at the core designing time, can be covered because reactivity and output power distribution can be controlled through operational manipulation. In the refueling operations conducted during a scheduled outage, on the other hand, safe operations cannot be performed without the evaluation of neutronic characteristics based on proper fuel burnup conditions.

That is, it is important in formulating a fuel transfer plan, which is the duty of the power plant site, to ensure the lead time for reflecting the information from the reactor core design and the process of feedback about the burnup conditions of the core fuel from the process computer to the design firm, and the quality of both of the above.

In addition, in a fuel transfer planning, subcriticality in the nuclear reactor core system of each step during the transfer needs to be ensured. For this reason, margin to the criticality of the core reactivity at the time of non-insertion of a single control rod, i.e. evaluation of the reactor shutdown margin and ensuring of the reactor shutdown margin during the transfer period, are required. For this matter, reflection of neutronic characteristics based on proper fuel burnup conditions is necessary, and said information needs to be applied from a process computer to the fuel transfer plan as soon as the operation cycle is completed.

Widely applied nuclear thermal hydraulic calculation models used for a process computer in evaluating reactor core performance are conventionally the modified 1 group theory model in which correction for the calculation of fast-group neutron flux distribution is taken into consideration of nuclear characteristics per neutron energy group and a three-dimensional diffusion calculation in which 24 calculation points are established per fuel assembly and in an axial direction, for a boiling water nuclear reactor. In recent years, further multiple group models such as 2 groups and 3 groups have been applied. With multiple models, the nuclear characteristics can be evaluated more precisely even for the fuel system in which fuel assemblies in the process of refueling at a scheduled outage are partly retrieved, although it takes more time.

Normally, in the evaluation of reactor shutdown margin in the fuel transfer planning, the modified 1 group or two-dimension model, or more simple and convenient correlation models are provided from multiple three-dimension models to achieve time reduction. However, in this case, provision of models and constants therefor are made by design firms to be provided to the power plant sites.

Fuel transfer plans manually made by power plant engineers in the past are now made automatically and more quickly by reflecting the arts such as “Japanese Patent No. 2945700 Supporting device for planning of fuel transfer.”

However, with the art of the Japanese Patent No. 2945700, the fuel database comprising neutronic characteristics and positional information of fuels needs to be constituted after the reactor core design is completed, and a sufficient lead time to starting the fuel transfer plan, including quality assurance of the database, needs to be ensured.

According to the art of “Japanese Paten Application Laid-Open Publication No. Hei 4-36692/1992 Reactor core operation management system,” the whole planning is automated by incorporating a fuel displacement planning means which automatically performs reactor core designing and a fuel transfer planning means, but update of the fuel database is still needed and an arrangement to reflect the data of a process computer is needed. In addition, these system input/output services need to be provided directly at the power plant site, but as previously mentioned it is difficult for the site engineers to conduct the management of the fuel neutronic characteristics database and analysis programs for designing for conducting the reactor core design.

According to the art of “Japanese Patent Application Laid-Open Publication No. 2005-121476 Fuel transfer procedure data generation device,” the evaluation of subcriticality as a limit value is conducted in the process of fuel transfer procedure formulation to narrow down the candidates for transfer, but means like this also requires a means for providing a proper neutronic characteristics database. In order to constitute a neutronic characteristics database in which the evaluation models for subcriticality provide more accuracy, it is necessary that detailed neutron flux distribution results, fuel exposure evaluation results and burnup variations of fissile material isotope nuclides of the reactor core, just as provided by the reactor core performance calculation of a process computer, are evaluated consistent with the track records of the nuclear reactor operation and prepared at least for all the composing fuels before the beginning of refueling (final-stage core in the preceding cycle) and at the end of the refueling (initial-stage core in the following cycle).

Important management items at a power plant site include evaluation of incoming/outgoing quantities and creation/annihilation levels and location management of fissile nuclides and parent material nuclide isotopes, and the creation/annihilation level evaluation is an Important function of the reactor core performance calculation of a process computer. In the power plant site management, normally the evaluation results from a process computer are managed for the total quantities and location together with fuel incoming/outgoing management using a nuclear fuel accounting system. Since the purpose of this isotope management is location management of fissile materials and parent materials, precise mass management and location management of isotope nuclide are required. In this regard, cooperation of process computers, nuclear fuel accounting systems and fuel transfer plans is important,

For example, according to the art of “Japanese Paten Application Laid-Open Publication No. 2000-162371 Fuel assembly nuclide calculation device and its calculation method,” whereas detailed evaluation by supplying country of creation/annihilation level of isotope nuclides can be performed, separate quality management processes are required for delivery/receipt to/from a nuclear fuel accounting system due to lack of a concept of location management.

Concerning spent-fuel storage racks, subcriticality shall be maintained in the situation that the fuel to be unloaded after fuel transfer is being located, and in order to confirm the situation, evaluation such as the neutron transport calculation for a spent fuel storage system is needed. The margin of subcriticality can be evaluated using the art of “Japanese Patent No. 3708599 Evaluation method for subcriticality of spent fuel assembly during storing in container system” etc., but provision of the nuclear constants is needed in this case as well, and if the power plant site intends to perform the evaluation, separate quality management processes are needed for data transmission/receipt between the design firm and the power plant site in order to interact the fuel burnup condition evaluation obtained from a process computer and the location management after fuel transfer.

At the same time, the storage racks provided as a fuel storage system in a fuel storage pool are not always constant through the lifecycle of the plant but may possibly require additional installation corresponding to the storage condition of the spent fuel or be changed for improved storage efficiency. In addition, in a case that intermediate storage facilities are located outside the plant, separate criticality safety evaluations are required. As for the criticality safety evaluation for storage racks inside the plant, if an evaluation system of the design firm is utilized, a quality management process for precisely transmitting from the power plant site to the design firm the conditions of storage systems and fuel transfer as inputs is required.

In addition, provision of the nuclear constant is required as well as the criticality safety evaluation for the spent-fuel storage racks also for the evaluation of neutron flux distribution to an in-core neutron detector, and in order to interact the fuel burnup condition evaluation obtained from a process computer and the location management after refueling, separate quality management processes are required for the transmission/receipt, in a case that proper physics models are not applicable to this evaluation, such restriction needs to be applied that burnup proceeds constantly around a neutron detector and the accumulated fuel of a spontaneous neutron source is maintained, for example.

As explained above, in spite of the fact that the burnup condition evaluation for each fuel which can be provided by a process computer is located at a power plant site, it is needed to consign design engineers to establish the individual nuclear fuel database in order for provision to be made to an independent downstream system, providing many problems in terms of quality management as well as requiring operation time.

Patent Document 1: Publication of Japanese Patent No. 2945700

Patent Document 2; Publication of Japanese Patent Application Laid-Open Publication No. Hel 4-36692/1992

Patent Document 3: Publication of Japanese Patent Application Laid-Open Publication No. 2005-121476

Patent Document 4; Publication of Japanese Patent Application Laid-Open Publication No. 2000-162371

Patent Document 5: Publication of Japanese Patent No. 3708599

### BRIEF SUMMARY OF THE INVENTION

### Problems to be Solved by the Invention

With the progress in capacity of computers in recent years, reactor core performance calculation of a process computer can perform predictive evaluation of various characteristics of a reactor core during the runtime with high accuracy if proper neutronic characteristics information of a reactor core to be managed is provided.

The burnup conditions of a core fuel depend on the following conditions in a case of a boiling water nuclear reactor: (1) the type, number and location of the fuel used to constitute the reactor core; (2) the nuclear reactor output level and duration during the operation period; (3) the number of control rods to be inserted, insertion patterns and the timing of the operations during the operation period; and (4) the level of the recirculation flow and the timing of the operations during the operation period. A process computer compiles the associated data with respect to the above using cycle logs to be able to provide such data.

However, in the conventional art, there has been no such refueling support system that is utilized through interaction with the output of a process computer at a power plant site. Consequently, the operation process steps that have been needed are that (1) the neutronic characteristics based on the output of a process computer are transmit to a design firm; (2) the design firm performs analytical evaluation; (3) necessary data for establishing fuel transfer procedures are constituted based on the analytical evaluation results; (4) the procedures are supplied into a fuel transfer procedure planning system at the power plant site; and (5) the site engineers utilize the constituted data.

In the above operation process, the data transmission/receipt and quality management in the operation processes at a design firm and a power plant site are required, and it requires substantial time before fuel transfer procedures are established, such as the waiting time occurred for the power plant site engineers before starting the operations.

In addition, it also requires substantial time, for the same reason, in the operations that require proper information about both the operating conditions of a nuclear reactor and the refueling during a scheduled outage, such as the isotope location management of nuclear materials associated with fuel transfer operations, the criticality safety evaluation in a spent-fuel storage rack system, etc.

Further, regarding the count evaluation for a neutron detector during fuel transfer, because prevention of a count lower limit of a start-up neutron detector is included among the conditions for establishing fuel transfer procedures, it has been difficult to transmit/receive the neutron characteristics and perform precise evaluation in a short time.

In such situations, the present invention provides a refueling support system in which fuel transfer procedure establishing operations and associated operations precisely reflecting the fuel burnup conditions can be efficiently performed at the time of scheduled outages at a nuclear power plant to solve the problems.

### Means for Solving the Problems

A refueling support system according to the invention of the present application is characterized by comprising:

a reactor core performance calculation means for evaluating neutronic characteristics per fuel assembly from core loading pattern input data of a reactor core before beginning of fuel transfer at the end of a predetermined cycle n and candidate reactor cores at the end of fuel transfer at the beginning of the following cycle n+1 and from core performance calculation results from a process computer;

a transfer condition setting means for determining an intermediate fuel loading pattern target which should be realized in the process of fuel transfer from transfer condition input data including intermediate fuels-to-be-unloaded and transfer priority levels; and

a transfer procedure planning means for determining fuel transfer procedures from the neutronic characteristics per fuel assembly which are output from said reactor core performance calculation means and from the intermediate fuel loading pattern target which is output from said transfer condition setting means.

Said reactor core performance calculation means can contract constants for three-dimensional multigroup calculation corresponding to neutronic characteristics models for simulation evaluation of neutronic and thermal characteristics of a reactor core into equal to or lower dimensions or equal to or lower group number calculation constants and provide such contraction as database of constants for reactor shutdown margin restriction evaluation at a time of determination of fuel transfer procedures.

In addition, a fuel loading pattern evaluation means for configuring location patterns of fuel bundles, guides and control rods at the periphery of a neutron detector, based on the transfer procedures which are output from said transfer procedure planning means; and a neutron instrumentation evaluation means for evaluating the quantities of spontaneous fissile isotopes and source intensity of nuclear reaction for neutron generation as a fixed neutron source in the fuel zone based on the location patterns of fuel bundles and control rods configured by said fuel loading pattern evaluation means, performing fixed neutron source calculation, and evaluating a neutron detector count rate based thereon can be comprised.

In addition, an isotope nuclide quantity location management means for connecting isotope weight evaluation results obtained by said reactor core performance calculation means with location and transfer information per fuel assembly, based on the transfer procedures which are output from said transfer procedure planning means, and providing locational information of isotopes per designated management zone can be comprised.

In addition, a criticality safety management means for evaluating subcriticality of a fuel assembly storage system in a fuel storage pool can be comprised.

### Effect of the Invention

According to a refueling support system of the invention of the present application, by comprising a reactor core performance calculation means, power plant site engineers can obtain core loading pattern input data including one or more candidates of initial core configurations for the following cycle from a design firm at the time point when the operation cycle is approaching to the final stage, and, with the reactor core performance calculation means, evaluate the burnup conditions per fuel that is identifiable in connection with the above configurational information at a given time.

This enables neutronic characteristics database regarding the loading patterns before and refueling, to be established shortly after the end of a operation cycle without delay from the fuel information data such as the isotopic composition, exposure, etc. for each fuel bundle.

A transfer condition setting means can specify intermediate fuels to be unloaded which should be realized during fuel transfer if the positioning of scheduled outage targets of in-core devices and the inspection work priority are given as fuel transfer conditions.

In addition, a transfer procedure planning means can formulate fuel transfer procedures based on the outputs from the reactor core performance calculation means and the transfer condition setting means, i.e. neutronic characteristics database per fuel and choice of the intermediate fuels to be unloaded, as restriction inputs.

Since the input to the transfer condition setting means can be decided and adjusted by power plant site engineers themselves, fuel transfer procedures also can be formulated for planning after the end of a operation cycle without delay. The neutronic characteristics per fuel are necessary not only for evaluating reactor core characteristics as represented by reaction shutdown margin in the process of fuel transfer but also for specifying fuels to be unloaded and visual examinations by exposures and criteria for fuels that should be remained around a detector. The evaluation of reactor core characteristics in the process of fuel transfer can easily be realized by giving feedback of core fuel loading patterns corresponding to transfer steps to the reactor core performance calculation means.

According to the invention of the present application comprising a reactor core performance calculation means which contracts constants for three-dimensional multigroup calculation corresponding to neutronic characteristics models for simulation evaluation of neutronic and thermal characteristics of a reactor core into equal to or lower dimensions or equal to or lower group number calculation constants and provides such contraction as database of constants for reactor shutdown margin restriction evaluation at a time of determination of fuel transfer procedures, power plant site engineers can input reactor shutdown margin restriction evaluation models and constants for evaluation that are simpler, more convenient and faster than application to reactor core performance calculation from the reactor core performance calculation means to the transfer procedure planning means. This enables fuel transfer procedures to be formulated for planning after the end of a operation cycle without delay in consideration of the reactor shutdown margin restriction at the time of formulation of transfer procedures.

According to the refueling support system of the invention of the present application comprising a fuel loading pattern evaluation means and a neutron instrumentation evaluation means, since the fuel loading pattern evaluation means can evaluate the location patterns of fuel assemblies, guides and control rods at a given time point based on transfer procedures and specify a effective range for a neutron source, the neutron instrumentation evaluation means can evaluate neutron flux distribution and the count rate of a neutron detector in proportion thereto by fixed neutron source calculation. The fixed neutron source calculation can be performed also by inputting an evaluation system to the reactor core performance calculation means or by inputting nuclear constant data or evaluation models to the extent necessary from the reactor core performance calculation means to the neutron instrumentation evaluation means. In order to ensure the count rate of a neutron detector in the process of fuel transfer, instead of making a decision from conventional empiric models, i.e. the exposures and the number of adjacent fuel assemblies, power plant site engineers can apply predicted count rate values of a neutron detector obtained by neutron flux distribution calculation in which substantial physical phenomena are simulated to the restriction evaluation in the transfer procedure planning means. As a result, the operative lower limit, 3 cps for example, of a start-up neutron detector can be ensured with a rational fuel loading pattern, and thus the latitude of fuel transfer procedures is extended.

According to the refueling support system of the invention of the present application comprising an isotope nuclide quantity location management means, while the isotope weights of fissile nuclides per fuel assembly can be evaluated at a given runtime point in the reactor core performance calculation means, the transfer information of each fuel between reactor cores or between a reactor core and a fuel storage pool can be specified in the transfer procedure planning means, and the isotope nuclide quantity location management means can connect both the above information and combine the same as a tabulated value per designated management zone. Power plant site engineers can therefore precisely tabulate isotope nuclide located quantities per fuel assembly at any given designated management zone of a reactor core, a fuel storage pool or a plant management boundary before and after fuel transfer. This enables the location management of fissile nuclide isotopes to be realized without delay through a operation-outage cycle of a power plant and with the data input/output quality management process to be streamlined, without separately providing fuel incoming/outgoing quantities, isotope weight changes, fuel transfer histories as inputs in an independent fuel accounting system. Since the data flows of associated evaluation amount and tabulation amount have consistency within this refueling support system, associated audit information can be retrieved at a given processing step.

In a case that the storage system in the spent fuel pool is not reconfigured, and the refueling support system includes a criticality safety management means, fixed input of the transfer procedure planning means is applicable. In a case that the storage system changes due to additional storage rack installation etc., the input of the transfer condition setting means 2 is provided. It is reasonable in terms of quality management that, since the change of a storage system results in the change of positioning management information in the fuel transfer procedures, the above input is performed by power plant site engineers. The information of this storage system can be provided as the nuclide quantity information constituting positional information and a storage system. In either cases, the isotope nuclide quantity location management means can tabulate the nuclide quantities per unit of fuel storage to manage (with a minimum unit corresponds with each fuel bundle) from the output of the transfer procedure planning means, and with the same composition, the nuclide quantities in the components of fuel assemblies and moderators, or stainless which constitute a guide, etc. can be tabulated. The criticality safety management means performs eigenvalue calculation for the whole storage system on which subcriticality evaluation should be conducted, by the transmitting/receiving method in common with the method in the neutron instrumentation evaluation means, based on the information of the nuclide quantities per unit of storage management associated with the fuel transfer of the above and the nuclide information of said storage system itself. This enable power plant site engineers to perform subcriticality evaluation without delay with respect to the storage system inside a fuel storage pool. In addition, a change of a storage system can also be flexibly responded.

### BRIEF DESCRIPTION OF THE SEVERAL VIEWS OF THE DRAWINGS

FIG. 1 is a structural block diagram showing a first embodiment of a refueling support system according to the present invention.

FIG. 2 is a structural block diagram showing a second embodiment of a refueling support system according to the present invention.

FIG. 3 is a structural block diagram showing a third embodiment of a refueling support system according to the present invention.

FIG. 4 is a structural block diagram showing a fourth embodiment of a refueling support system according to the present invention.

FIG. 5 is a structural block diagram showing a modification of a fourth embodiment of a refueling support system according to the present invention.

### DETAILED DESCRIPTION OF THE INVENTION

Embodiments of the present invention will be explained herein below with reference to the drawings.

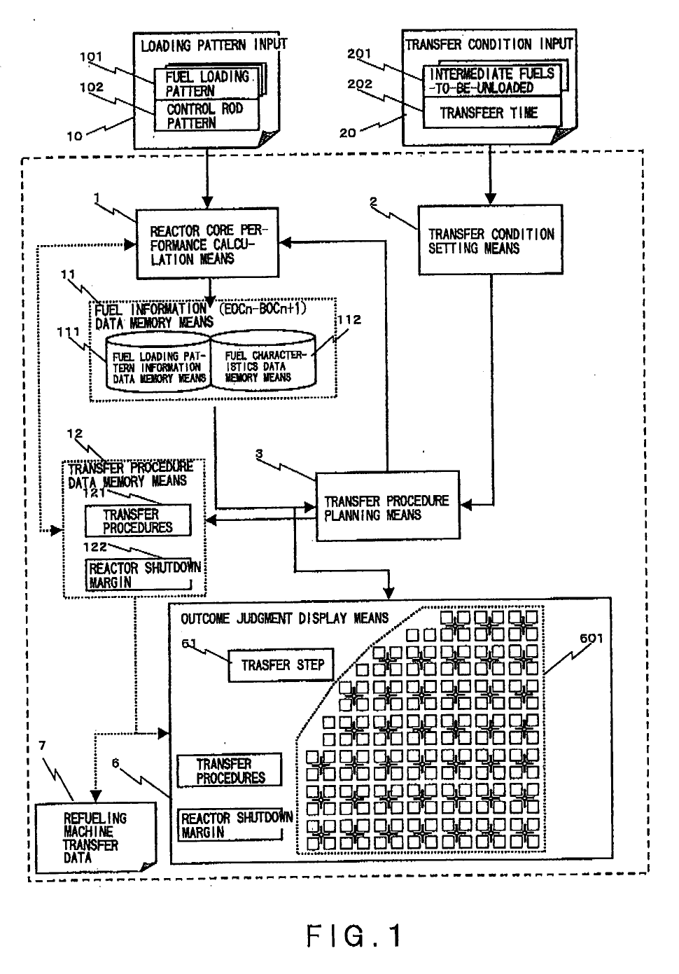

FIG. 1 is a structural block diagram showing a first embodiment of a refueling support system according to the present invention.

The refueling support system according to the present embodiment comprises a reactor core performance calculation means 1 reactor, a fuel information data memory means 11, a transfer condition setting means 2, a transfer procedure planning means 3, a transfer procedure data memory means 12 for storing fuel transfer procedures and reactor shutdown margin evaluation values, and a outcome judgment display means 6.

To the reactor core performance calculation means 1, core loading pattern input data 10 including a fuel loading pattern 101 and a control rod pattern 102 are provided as inputs.

The fuel loading pattern 101 defines a fuel loading pattern in a reactor core before beginning of refueling for a cycle n, EOCn, which has already been operated, and a fuel loading pattern in a reactor core at the end of refueling for the cycle n+1, BOCn+1, obtained from a continued reactor core design.

Preferably, the reactor core performance calculation means 1 compiles the histories of the fuel loading pattern 101 and the control rod pattern 102 in synchronization with a process computer, performs burnup simulations, evaluates the quantities of nuclide isotopes of each fuel at the end of the operating cycle, and determines a fuel neutronic characteristics.

As for a reactor core at the end of refueling, there are a new fuel and a reload fuel, and the fuel neutronic characteristics of the new fuel have been fixed, and the fuel neutronic characteristics of those fuels are provided by the reactor core loading pattern input data 10. The fuel neutronic characteristics of a reload fuel can be determined, as the corresponding fuel can be retrieved from the reactor core before beginning of refueling.

As a consequence, the reactor core performance calculation means 1 can store the fuel loading pattern information of the reactor core before beginning of refueling and of the reactor core at the end of refueling in a fuel loading pattern information data memory means 111 and the corresponding fuel neutronic characteristics in a fuel neutronic characteristics data memory means 112, as fuel information data. These fuel loading pattern information of the reactor core before beginning of refueling and of the reactor core at the end of refueling and the corresponding fuel neutronic characteristics are provided as inputs of the transfer procedure planning means 3.

In the case of the fuel loading pattern 101 for the reactor core at the end of refueling, BOCn+1, a plurality of data are manageable and applicable as candidates for the reactor core at the end of refueling, as design firms normally examine a plurality of designs. Since the fuel information data memory means 11 can also manage the data by case, the input time may be divided into a plurality of times.

As the input to the transfer condition setting means 2, transfer condition input data 20 including intermediate fuels-to-be-unloaded 201 and transfer priority levels 202 are provided.

The intermediate fuels-to-be-unloaded 201 define a combination of target positions and ranges of fuel unloading in accordance with the maintenance conditions of control rods, detectors, visual examinations of the fuel, etc.

The transfer priority levels 202 define conditions to unload fuels in a checkered manner in advance to guarantee subcriticality, place higher priority on unloading relating to a device for operations with higher priority, and ensure the time period for operations.

These transfer condition input data 20 change at every scheduled outage and thus are adjusted and determined by the power plant site engineers. Other semi-fixed transfer conditions include definition of the location of storage racks for fuel storage pool, and in some cases purposes are assigned thereto, such as for new and spent fuel batches, as temporary placement (temporary intermediate unloading) spaces, for visual examinations, for guiding, etc. Normally, the transfer condition setting means 2 reviews and adjusts the consistency of the transfer condition input data 20 and determines an intermediate fuel loading pattern target which should be realized in the process of refueling, which are then input to the transfer procedure planning means 3.

Based on the outputs from the reactor core performance calculation means 1 and the transfer condition setting means 2, i.e. neutronic characteristics database per fuel and choice of the intermediate fuels-to-be-unloaded, as restriction inputs, the transfer procedure planning means 3 formulates transfer procedures 121, When the transfer procedure planning means 3 feedbacks the transfer procedures 121 to the reactor core performance calculation means 1, the reactor core performance calculation means 1 which can evaluate any given fuel loading pattern in the process of transfer procedures evaluates reactor shutdown margin 122 by calculating the reactor core performance and then stores the reactor shutdown margin 122 in the transfer procedure data memory means 12 in the form corresponding to the transfer procedures 121.

The outcome judgment display means 6 displays a core fuel loading pattern 601 in a given transfer step 61 and a pool fuel loading pattern (not shown) based on the fuel loading pattern information at the fuel loading pattern information data memory means 111 of the fuel information data memory means 11 and the transfer procedures 121 of the transfer procedure data memory means 12. Also the transfer procedures 121 and the reactor shutdown margin 122 corresponding to the transfer step 61 are displayed. The displayed transfer procedures 121 may be work instruction sheet for the refueling operation workers or can be converted into the form of refueling machine transfer data 7.

The display of the core fuel loading pattern 601 in the outcome judgment display means 6 may be combined with a graphic interface which displays reactor core performance calculation results from the reactor core performance calculation means 1, and preferably the information at the fuel information data memory means 11 is displayed in connection with the relevant fuel positions of the core fuel loading pattern 601.

In addition, the display may be in connection with the relevant control rod positions of the core fuel loading pattern 601 because normally, in reactor shutdown margin calculation, not only the minimum reactor shutdown margin but the reactor shutdown margin per withdrawable control rod is being obtained. It can easily be realized to color-code the display in connection with the calculation results or ranking, or to provide visual effects such as flashing to the display.

Regarding the connection of a fuel with its position, the fuel may be displayed accompanied by the positional information, or specific information of each fuel may be displayed on the graphic display of the core fuel loading pattern 601.

Evaluation of reactor shutdown margin is also necessary in the process of transfer procedure planning, but simplified reactor core performance calculation of the reactor core performance calculation means 1 may be applicable in this regard. The reactor core performance calculation means 1 may contract constants for three-dimensional multigroup calculation corresponding to neutronic characteristics models for simulation evaluation of neutronic and thermal characteristics of a reactor core into equal to or lower dimensions or equal to or lower group number calculation constants and provide such contraction as database of constants for reactor shutdown margin restriction evaluation at a time of formulation of transfer procedures. Reactor shutdown margin restriction evaluation models and constants for evaluation that are simpler, more convenient and faster than application to reactor core performance calculation can be included in the fuel information data memory means 11 to be input from the reactor core performance calculation means 1 to the transfer procedure planning means 3.

According to the first embodiment of a refueling support system of the present invention, the histories of the fuel loading patterns and control rod patterns received from design firms can be compiled and thus be properly chosen and applied to formulation of transfer procedures by power plant site engineers.

In addition, since the reactor core performance calculation means 1 also can evaluate the exposure of each fuel type or the control rod neutron irradiation dose at the end of a run cycle, automation of the choice of control rods subject to exchange and fuels subject to visual examinations that are normally included in the transfer condition input data 20, or judgment of consistency between the transfer condition input data 20 and the choice by evaluation can be realized easily.

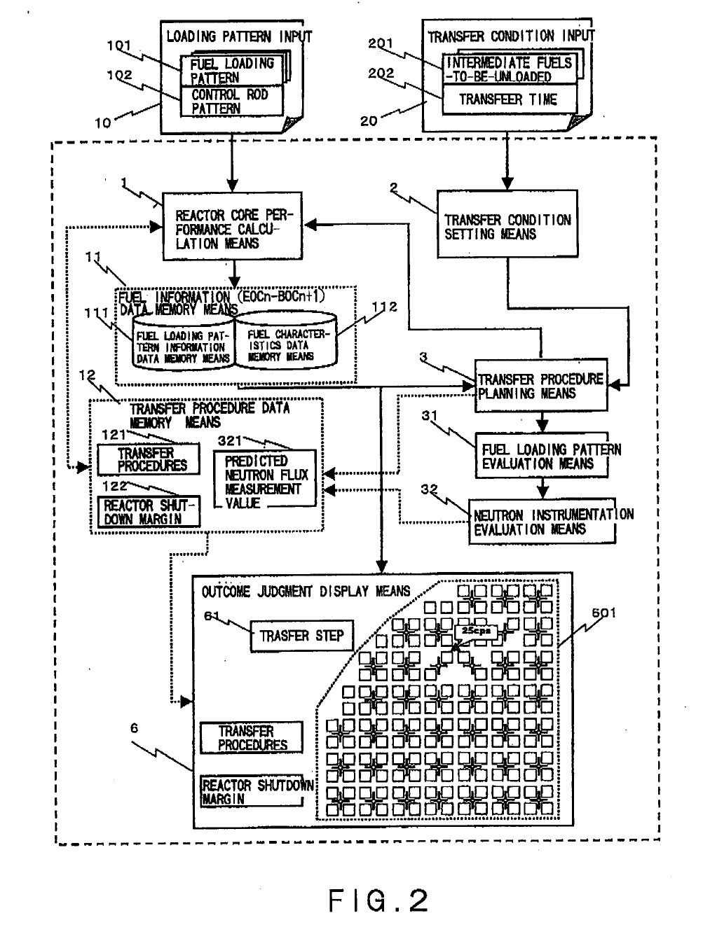

FIG. 2 is a structural block diagram showing a second embodiment of a refueling support system according to the present invention.

The refueling support system of the second embodiment of the present invention comprises a reactor core performance calculation means 1, a fuel information data memory means 11, a transfer condition setting means 2, a transfer procedure planning means 3, a transfer procedure data memory means 12 for storing fuel transfer procedures and reactor shutdown margin evaluation values, a fuel loading pattern evaluation means 31, a neutron instrumentation evaluation means 32, and an outcome judgment display means 6.

Of the refueling support system according to this second embodiment the reactor core performance calculation means 1, fuel information data memory means 11, transfer condition setting means 2, transfer procedure planning means 3, transfer procedure data memory means 12 and outcome Judgment display means 6 and those in the first embodiment are common, and the fuel loading pattern evaluation means 31 and the neutron instrumentation evaluation means 32 are further added in this embodiment.

In this embodiment, the fuel neutronic characteristics made by the reactor core performance calculation means 1 and of a fuel neutronic characteristics data memory means 112 of the fuel information data memory means 11 are to include nuclear constants for fixed neutron source lattice calculation and the quantities of fissile isotopes.

The fuel loading pattern evaluation means 31 configures a core fuel loading pattern for each transfer step based on the fuel loading pattern information included in a fuel loading pattern information data memory means 111 of the fuel information data memory means 11 and transfer procedures 121 of the transfer procedure data memory means 12, and obtains the fuel neutronic characteristics corresponding to the composed fuel from the fuel neutronic characteristics data memory means 112.

The fuel loading pattern evaluation means 31 specifies, and supplies to the neutron instrumentation evaluation means 32, the whole core fuel or the fuel assembly (e.g. 6×6 assembly) in a predetermined range around a start-up neutron detector and a neutron source contained therein.

The neutron instrumentation evaluation means 32 evaluates the quantities of spontaneous fissile isotopes and source intensity of nuclear reaction for neutron generation as a fixed neutron source in the fuel zone supplied by the fuel loading pattern evaluation means 31. Based on this evaluation, fixed neutron source calculation is performed to evaluate the neutron flux distribution of the start-up neutron detector, and by multiplying the calculated result by a detector sensitivity coefficient, a predicted neutron flux measurement value 321 is obtained. In a case that a plurality of channels obtains the set of the start-up neutron detector and the predicted neutron flux measurement value 321, the minimum predicted neutron flux measurement value 321 of a channel is specified. The neutron instrumentation evaluation means 32 stores the predicted neutron flux measurement value 321 in the transfer procedure data memory means 12 in the form corresponding to the transfer procedures 121.

An outcome judgment display means 6 of the second embodiment displays a core fuel loading pattern 601 in a transfer step 61, refers to the predicted neutron flux measurement value 321 from the transfer procedure data memory means 12 at the display, and associates the display with the corresponding detector position. The display of the predicted neutron flux measurement value 321 may be a numerical value of the predicted value, graphic display or color-coded display. It is particularly effective that the display is made to alert when the count values fall below the lower limit.

Note that the transfer procedure planning means 3 can utilize the predicted neutron flux measurement value 321 in connection with transfer procedures and thus can modify the transfer procedures to keep the values from falling too low. In addition, the neutron instrumentation evaluation means 32 can perform fixed neutron source calculation also by inputting an evaluation system to the reactor core performance calculation means 1 or by inputting nuclear constant data or evaluation models to the extent necessary from the reactor core performance calculation means 1 to the neutron instrumentation evaluation means 32.

According to the refueling support system of the second embodiment, power plant site engineers can evaluate the presence of an operative lower limit of a start-up detector that should be prevented from occurring in advance or automatically adjust transfer procedures prevent such occurrence, at the formulation of the transfer procedures.

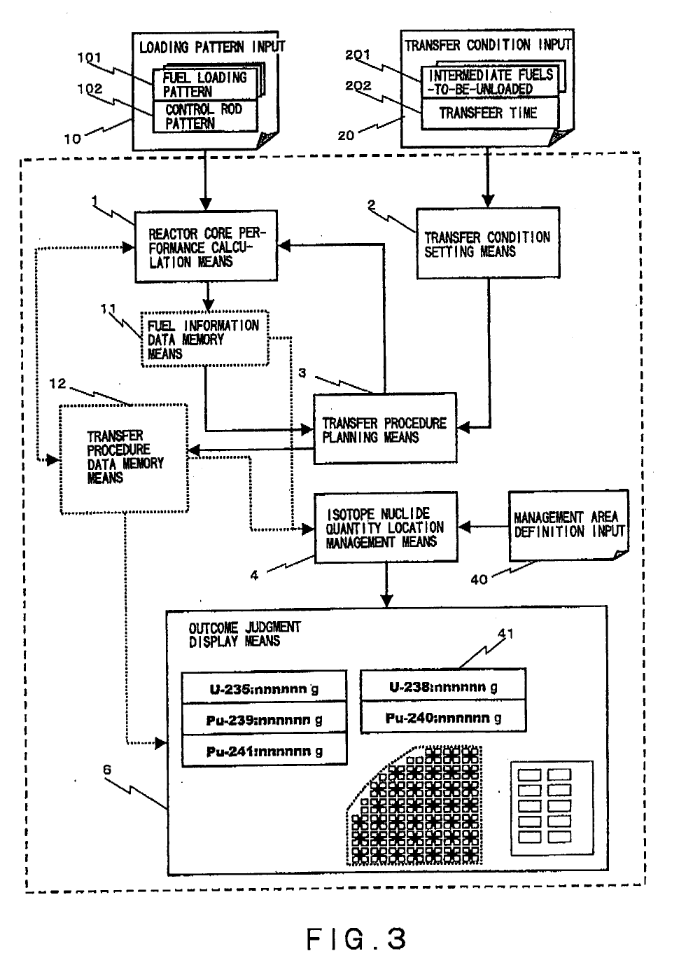

FIG. 3 is a structural block diagram showing a third embodiment of a refueling support system according to the present invention.

The refueling support system of the third embodiment of the present invention comprises a reactor core performance calculation means 1, a fuel information data memory means 11, a transfer condition setting means 2, a transfer procedure planning means 3, an isotope nuclide quantity location management means 4 for providing locational information of isotopes per designated management zone, and an outcome judgment display means 6.

Of the refueling support system according to this third embodiment the reactor core performance calculation means 1, transfer condition setting means 2, and transfer procedure planning means 3 and those in the first embodiment are common, and the isotope nuclide quantity location management means 4 is particularly provided in this embodiment.

In this embodiment, since fissile nuclides and parent nuclide isotope quantities are evaluated in the reactor core performance calculation means 1, the fuel neutronic characteristics of the fuel neutronic characteristics data memory means 112 of the fuel information data memory means 11 are to include fissile nuclides and-the quantities of parent nuclide isotopes.

Because fissile nuclides and parent nuclide isotopes (mainly uranium and plutonium) are very important in terms of economic value and security management, incoming/outgoing management and creation/annihilation balance management (i.e. accounting) are needed by gram, and such accounting function can be realized according to the refueling support system of the third embodiment.

The isotope nuclide quantity location management means 4 connects fissile nuclides and parent nuclide isotope quantities of the fuel neutronic characteristics data memory means 112 with locational/transfer information per fuel assembly.

Then, based on a management area definition input 40 which defines a management area as a boundary of incoming/outgoing accounting, the locational information of isotopes are tabulated per designated management zone.

Since, incoming/outgoing of fuel assemblies between the designated management zones can be evaluated through the transfer procedures 121 which are established in the transfer procedure planning means 3 and stored in the transfer procedure data memory means 12, the isotope nuclide quantity location management means 4 can tabulate the isotope nuclide quantities per designated management zone at the beginning and end of the refueling.

An outcome judgment display means 6 of the third embodiment can display isotope nuclide quantities 41 per designated management zone mentioned above.

According to the refueling support system of the third embodiment, while the isotope weights of fissile nuclides per fuel assembly at a given runtime point can be evaluated in the reactor core performance calculation means 1, the transfer information of each fuel between reactor cores or between a reactor core and a fuel storage pool can be specified in the transfer procedure planning, means 3, and the isotope nuclide quantity location management means 4 can connect both the above information and combine the same as a tabulated value per designated management zone.

Power plant site engineers can therefore precisely tabulate isotope nuclide located quantities per fuel assembly at any given designated management zone of a reactor core, a fuel storage pool or a plant management boundary before and after refueling. This enables the location management of fissile nuclide isotopes to be realized without delay through a operation-outage cycle of a power plant and with the data input/output quality management process to be streamlined.

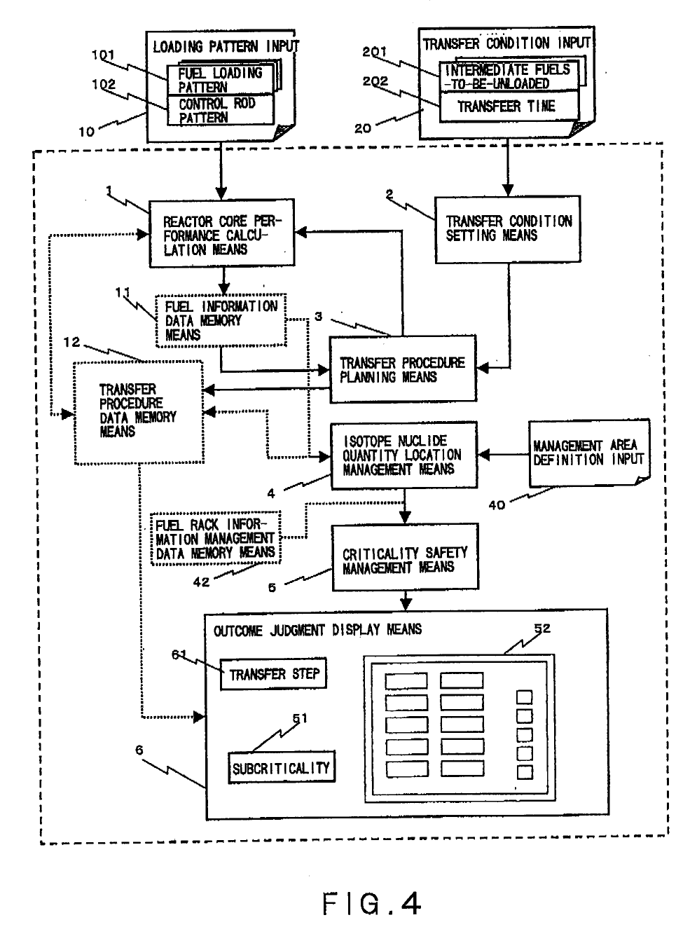

FIG. 4 is a structural block diagram showing a fourth embodiment of a refueling support system according to the present invention.

The refueling support system of this fourth embodiment of the present invention comprises a reactor core performance calculation means 1, a fuel information data memory means 11, a transfer condition setting means 2, a transfer procedure planning means 3, an isotope nuclide quantity location management means 4 for providing locational information of isotopes per designated management zone, a criticality safety management means 5 which evaluates subcriticality of a fuel assembly storage system with a neutron intensity evaluation code system, and an outcome judgment display means 6.

At this point, a management area definition input 40 is performed per fuel assembly, and the isotope nuclide quantities per designated management zone which are output from the isotope nuclide quantity location management means 4 are stored in a fuel rack information management data memory means 42. Note that the management area definition input 40 is provided as a nuclide quantity information which constitutes positional information and storage racks.

From the output of the transfer procedure planning means 3, the isotope nuclide quantity location management means 4 tabulates the nuclide quantities per unit of fuel storage pool storage management (with a minimum unit of fuel assembly) and stores isotope nuclide quantities per designated management zone in the fuel rack information management data memory means 42.

With the same arrangement, the nuclide quantities in the components of fuel assemblies and moderators, or stainless which constitute a guide, etc. are tabulated, and the structural material nuclide quantities per designated management zone are stored in the fuel rack information management data memory means 42. In addition, regarding the isotope nuclide quantities per designated management zone and the structural material nuclide quantities per designated management zone, the isotope nuclide quantity location management means 4 retrieves the neutronic characteristics per nuclide from the fuel information data memory means 11 and stores such neutronic characteristics in the fuel rack information management data memory means 42.

The nuclides comprising guides and fuel racks are, if not included in default embedded libraries of the reactor core performance calculation means 1, setup to be included in the management area definition input 40.

The criticality safety management means 5 performs eigenvalue calculation for the whole storage system on which subcriticality evaluation should be conducted, by the transmitting/receiving method in common with the method in the neutron instrumentation evaluation means 32 of the refueling support system of the second embodiment, based on the information of the isotope nuclide quantities per designated management zone associated with fuel transfer in the fuel rack information management data memory means 42, the structural material nuclide quantities per designated management zone, and the nuclide information of the above.

That is, spontaneous fissile isotope quantities and furthermore source intensity of the nuclear reaction for neutron generation are evaluated as a fixed neutron source in a fuel zone to perform eigenvalue calculation. This allows a subcriticality 51 to be obtained, but also the criticality safety management means 5 can divide the storage system into sub-sectors per storage rack etc. to perform eigenvalue calculation per sub-sector to obtain subcriticality data for subcriticality display by rack, 52.

The outcome judgment display means 6 outputs the subcriticality 51 and by-rack subcriticality display 52. Regarding the by-rack subcriticality display 52, a drawing area is decided through the positional information of storage racks of the management area definition input 40, and a color-coded identification can be displayed corresponding to the subcriticality 51. It is particularly effective that the display is made to alert when the degree of subcriticality is small.

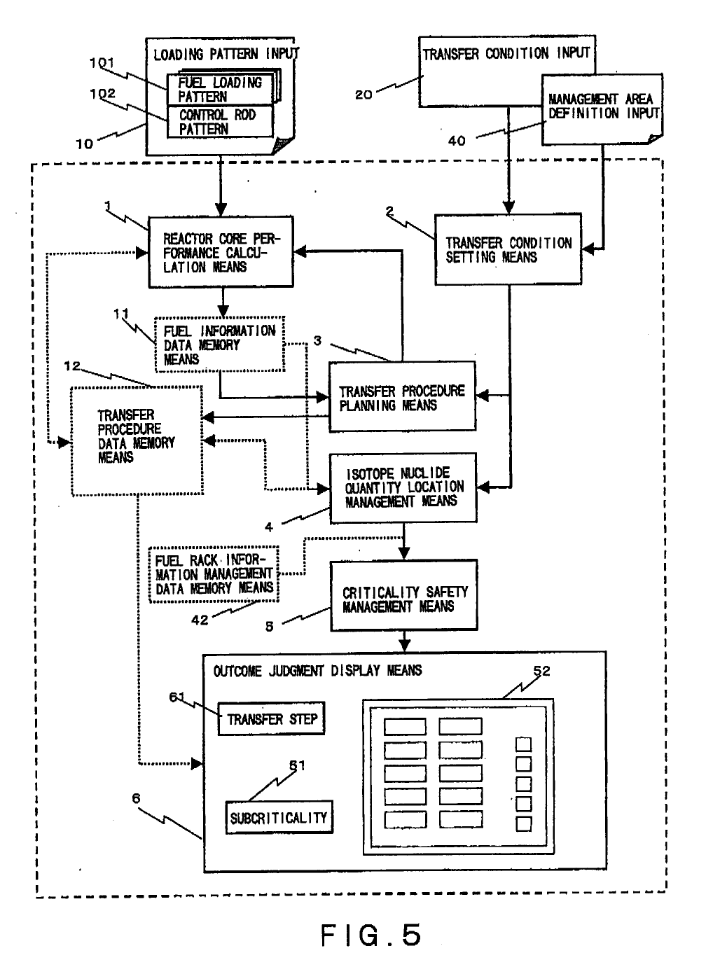

In the refueling support system of the fourth embodiment of the present invention, in a case that the storage system in a fuel storage pool is constant, fixed input of the transfer procedure planning means 3 is available, but in a case that the storage system changes due to additional storage rack installation etc., the management area definition input 40 becomes the input of the transfer condition setting means 2, as shown in FIG. 5. Since the change of a storage system results in the change of positioning management information in the fuel transfer procedures, the above input is performed by power plant site engineers.

In either cases, with or without the change of storage system in a fuel storage pool, power plant site engineers can perform subcriticality evaluation without delay according to the refueling support system of the fourth embodiment of the present invention, and thus the subcriticality management of the storage system in a pool can be realized without delay through a operation-outage cycle of a power plant and with the data input/output quality management process to be streamlined.

Note that change of the position of a fuel storage pool to be used when the degree of subcriticality is small can be easily realized by giving feedback of the subcriticality 51 from the criticality safety management means 5 to the transfer condition setting means 2 and adding conditions to restrict installation of a fuel with a certain exposure or above concerning the storage rack with the small degree of subcriticality 51, for example.

According to the refueling support system of the present invention, reactor core characteristics evaluation results constitute reactor core characteristics data, and characteristics of fuels used for fuel transfer planning or fixed neutron source calculation constitute fuel information data, but these data also can be accessed via network. In addition, a reactor core performance calculation means and a transfer procedure planning means are comprised as main process means of the refueling support system of the present invention, but these are not limited to a single computing device but may be dispersed computing devices. Agent computing which executes remote commands, or web services. The present invention can thus be realized as a processing system which functions through networking including the internet.

According to the present invention hereinabove, the data interface between design firms and a power plant site is streamlined so that the power plant site engineers themselves can perform associated operations required at the time of scheduled outages without going through the process of consigning the evaluation works to design firms, and thus the waiting time for the associated operations of power plant site engineers can be reduced, and a refueling support system which improves the quality of data can be provided.

In addition, according to the refueling support system of the present invention, after a nuclear core is shutdown or at the time that draft fuel loading patterns for the next cycle is provided, the neutronic characteristics per fuel assembly are evaluated without delay and assuredly applied to fuel transfer planning, and thus the fuel transfer procedures can be presented to power plant site engineers at the time of starting a scheduled outage. Since the data can be transmitted/received via external systems and recording media only for draft fuel loading patterns, confirmation by counterchecking concerning neutronic characteristics becomes unnecessary. Consequently, the data transfer/processing/verification time can be reduced. Since the count evaluation for neutron detectors during refueling also can easily be realized, fuel transfer procedures in which the count lower limit of a start-up neutron detector is prevented can be established. In addition, since the reactor core performance calculation results can immediately be applied to the evaluations of fuel exposures and control rod neutron irradiation dose, automation of designation or consistency judgment of the fuel subject to visual examinations and control rods subject to exchange becomes possible.

Further, regarding the operations that require proper information of both the running conditions of a nuclear reactor and the refueling during a scheduled outage, such as isotope location management for nuclear materials and criticality safety evaluation in a spent-fuel storage rack system related to fuel transfer operations, the neutronic characteristics per fuel assembly can be evaluated without delay, and thus efficient operation running becomes possible. The functions of isotope location management and criticality safety evaluation of the refueling support system of the present invention are continuously applicable even in a case that an isotope location management boundary is changed or that a spent-fuel storage rack system is changed.

In this way, the refueling support system of the present invention can efficiently support fuel transfer planning operations and associated operations in which necessary conditions are reflected assuredly.

What is claimed is:

1. A refueling support system characterized by comprising:
a reactor core performance calculation means for evaluating neutronic characteristics per fuel assembly from core loading pattern input data of a reactor core before beginning of refueling at the end of a predetermined cycle n and candidate reactor cores at the end of refueling at the beginning of the following cycle n+1 and from core performance calculation results from a process computer; a transfer condition setting means for determining an intermediate fuel loading pattern target which should be realized in the process of fuel transfer from transfer condition input data including intermediate fuels-to-be-unloaded and transfer priority levels; and
a transfer procedure planning means for determining fuel transfer procedures from the neutronic characteristics per fuel assembly which are output from said reactor core performance calculation means and from the intermediate fuel loading pattern target which is output from said transfer condition setting means.

2. A refueling support system according to claim 1 characterized in that said reactor core performance calculation means contracts constants for three-dimensional multigroup calculation corresponding to neutronic characteristics models for simulation evaluation of neutronic and thermal characteristics of a reactor core into equal to or lower dimensions or equal to or lower group number calculation constants and provides such contraction as database of constants for, reactor shutdown margin restriction evaluation at a time of determination of fuel transfer procedures,

3. A refueling support system according to claim 1 characterized by comprising:.
a fuel loading pattern evaluation means for configuring location patterns of fuel bundles, guides and control rods at the periphery of a neutron detector, based on the transfer procedures which are output from said transfer procedure planning means; and
a neutron instrumentation evaluation means for evaluating the quantities of spontaneous fissile isotopes and source intensity of nuclear reaction for neutron generation as a fixed neutron source in the fuel zone based on the location patterns of fuel bundles and control rods configured by said fuel loading pattern evaluation means, performing fixed neutron source calculation, and evaluating a neutron detector count rate based thereon.

4. A refueling support system according to claim 1 comprising an isotope nuclide quantity location management means for connecting isotope weight evaluation results obtained by said reactor core performance calculation means with location and transfer information per fuel assembly, based on the transfer procedures which are output from said transfer procedure planning means, and providing locational information of isotopes per designated management zone.

5. A refueling support system according to claim 4 characterized by further comprising a criticality safety management means for evaluating subcriticality of a fuel assembly storage system in a fuel storage pool.
